(19) United States
(12) Patent Application Publication
(10) Pub. No.: US 2021/0334757 A1
(43) Pub. Date: Oct. 28, 2021

(54) CAREER NAVIDEER FOR CAREER EXPLORATION AND EXPOSURE

(71) Applicants: Paris Gamble, Edmond, OK (US); Anthony Lyndon DePass, Freehold, NJ (US)

(72) Inventors: Paris Gamble, Edmond, OK (US); Anthony Lyndon DePass, Freehold, NJ (US)

(73) Assignee: Lifestyle Learning LLC, Edmond, OK (US)

(21) Appl. No.: 16/858,911

(22) Filed: Apr. 27, 2020

(51) Int. Cl. G06Q 10/10; G06F 16/9535; G06Q 30/02; G06Q 50/20; G09B 19/00

(52) U.S. Cl. CPC G06Q 10/105; G06F 16/9535; G09B 19/00; G06Q 50/2057; G06Q 30/0206

(57) ABSTRACT

A system for career exploration and exposure is provided comprising a computer application stored in the computer that, when executed, receives a first message from a client device, the first message providing at least specifications for a future lifestyle and describing vocational interests of a party interested in the future lifestyle. The system also determines cost of the desired future lifestyle and determines occupations associated with the described vocational interests. The system also determines a subset of the occupations able to afford the desired lifestyle based at least on the determined cost, and sends a second message to the client device, the second message communicating the subset of occupations. The specifications comprise at least one of the party's desired residence location, the user's desired housing arrangements, the user's eating habits, the user's transportation requirements, and the user's preferences for children, pets, and luxuries.

### CROSS REFERENCE TO RELATED APPLICATIONS

The present disclosure is related to U.S. Provisional Patent Applicant No. 62/905,032 filed Sep. 24, 2019, the contents of which are included herein in their entirety.

### FIELD OF THE INVENTION

The present disclosure is in the field of career and life management. More particularly, the present disclosure provides systems and methods of learning a user's lifestyle and career objectives and mapping the user's personal and academic choices for a career path that will enable the user to achieve these objectives.

### BACKGROUND

People express desires for current and future lifestyles as well as career goals but often view the desired lifestyles and career goals as separate and often unrelated endeavors. People often do not see the direct associations that lifestyle desires and career choices and objectives have with each other. They are unable to map academic and career paths leading to career goals that might afford the type of lifestyles that they seek. As lifestyles are based on a number of factors including persons' values, making long term career decisions that may be based on numerous short-term decisions informed by changing values can be challenging. Academic curriculum decisions are an important part of such long-term decision making based on the numerous short-term decisions constantly required of young people. Tools to assist persons in mapping academic and other curriculum decisions to achieve long term career and lifestyle goals do not presently support realistic decision making for students.

### BRIEF DESCRIPTION OF THE FIGURES

FIG. 1 is a diagram of a system of career navideer for career exploration and exposure according to an embodiment of the present disclosure.

### DETAILED DESCRIPTION

Systems and methods are provided herein to receive inputs describing a desired current or future lifestyle for a user, to calculate future user income levels required to support the desired lifestyle based on the inputs, and to determine occupations that may afford such future income levels and hence afford the desired lifestyle. The determined occupations may be limited to those associated with vocational interests expressed by the user. For users including students, adults contemplating career change, and others, the Career Navideer application comprising a suite of modules is provided that, based on further inputs including present age and education level achieved to date, may recommend further education and other actions necessary to qualify for an occupation of interest and associated desired lifestyle. Systems and methods provided herein may be used for career exploration, career readiness, career counseling, career assessment, financial literacy and financial planning.

The modules comprising the Career Navideer application share resources and software. They may be web-based and accessible by client devices including mobile devices and desktop computers. A device user may enter aspects of a desired lifestyle including residence location, housing, transportation, dietary needs, preferences for children and/or pets, and luxuries including periodic vacations. A Lifestyle Survey module provided by the Career Navideer application determines costs for each aspect of the desired lifestyle. The Lifestyle Survey module calculates annual income levels that includes a savings component such that the user would be able to support his/her desired.

The modules of the Career Navideer application perform many iterations based on ranges of assumptions for such factors as cost of living and median salary. The applications may rely on actuarial methods and established data to drive its calculations of needed income given various lifestyles. The modules also rely on historical data and economic projections about changes in the cost of living.

As noted, Career Navideer is web-based and mobile ready. The user may log into the application from a mobile device or from a desktop device.

Systems and methods provide different interfaces for various types of users. Each interface provides a dashboard for the user and allows the user to create a profile. The user enters extensive descriptive information about him/herself.

A first interface is for students and a second interface is for adults. The third interface is for organizational users, which could include administrative personnel or career guidance advisors.

The student interface, which is directed to high school and middle school students, allows the student to enter their school information and grades achieved to date. The student is advised that the survey process is designed to help the student uncover what lifestyle he or she desires.

Questions presented to the student focus on six areas: where and how the student wants to live, how the student wants to eat, and what kind of transportation the student desires. The student is also asked what type of family life he/she wants and what additional luxury items the student might want. Once the student enters his/her choices, the application calculates how much income the student might need. This is expressed as a Lifestyle Index.

The survey questions are presented in a graphical manner that is easy for a student to understand and is fun for the student to work with. Photographs and user-friendly graphics are provided to assist the student in making choices.

After dollar amounts of a chosen lifestyle are calculated, the Career Navideer application identifies potential occupations for the student. A career exploration module gives the student access to a wealth of information about specific careers that will allow the student to have the desired lifestyle. STEM (Science Technology Engineering and Mathematics) occupations are clearly identified. The display of occupations can be easily filtered by selecting specialized categories. The student is provided the ability to review job titles, minority underrepresentation, wages & employment trends, education, tasks, tools used, technology used, knowledge, abilities, skills, work activities, work context, job zone, interests, work styles, work values, related occupations, middle school/high school classes and post secondary certifications to help prepare for success in a career of interest. Video and audio files links about careers are available to better engage the student.

Student users can play an online game to map out an educational path for a specific school grade. A student is given a choice of choosing required academic classes, optional academic classes and extracurricular activities to get a high score and to map a path that will begin to lead to building skills in an occupation of interest.

The student's choices while using the application is captured and catalogued. The repository of saved material is available to the student in the form of reports by clicking on a MY METRICS button. Reports are available that are designed to assist communication between a parent and child, guidance counselor, or teacher. The reports may be used to guide a student's future academic and career decision-making. Various career profiles are also produced by the application.

The second interface is for adult users. As with the student interface, the adult user enters identifying and descriptive information and creates a profile. All of the functionality previously identified for the student user is available for the adult user, except the Game.

To filteri careers, the adult user may limit careers by educational level, work activities and work value. Work activities are general types of job behaviors that occur across multiple careers. They can include information input, interacting with others, mental processes and work output. Work values are aspects of work that are important to a person's satisfaction. Work values include achievement ,independence, recognition, relationships, support and working conditions.

The adult user is provided the opportunity to override the current calculated Lifestyle Index to see a revised list of careers. The adult user manually enters a new Lifestyle Index value and then recalculates.

As with the student interface, the choices that the adult user have made are saved. Similarly, the adult user may generate reports based on the choices and decisions made in the application.

Both student and adult users can create or update their user profiles and personalize their experiences by creating an avatar, selecting a guru and selecting theme music.

In addition, both student and adult users can review the celebration of completing their experience. They may also view reports that capture choices made in the application and display detailed career information that can be used for decision-making and further discussion.

The third interface provided herein is for organizational administrators and staff users. Systems and methods provided herein can be used for large groups in institutional settings, such as schools in the case of students or job placement organizations in the case of unemployed or career-changing adults.

This interface allows an administrative user, such as a guidance counselor, to follow and manage the progress of many persons as they use the program provided herein. This type of user can access each user's reports that they are responsible for to aid in discussions with students and others.

Organizational administration users can update their organization profile and create or modify organizational structure and organizational staff and student user accounts. Organizational administration users can also view limited student user information. They may also view reports that capture and summarize data and a high level that can be used for organizational decision-making

Organizational staff users can update their user profile and view detailed student user information. Organizational staff users can also view any student user-generated report and monitor student user progress.

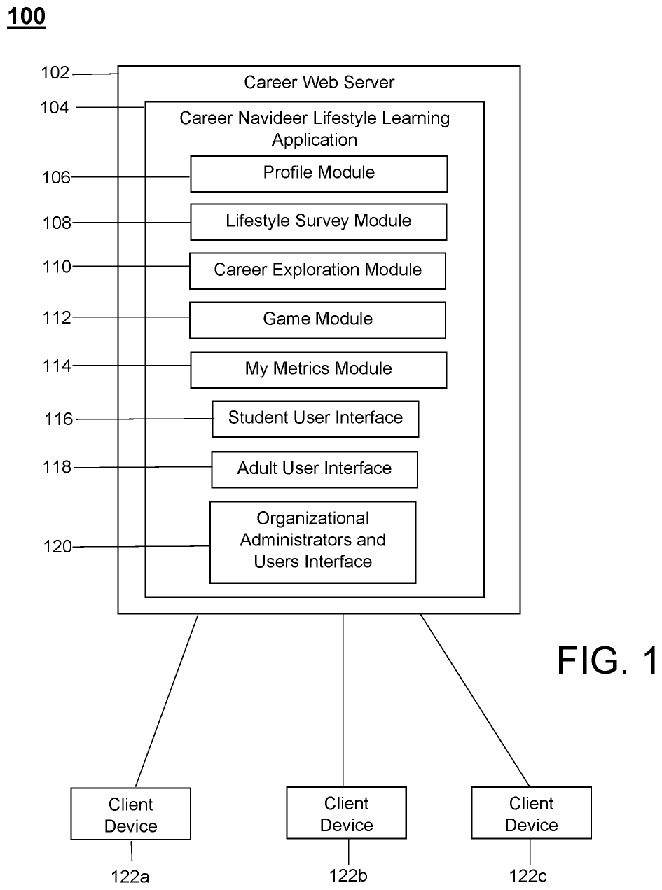

Turning to the figures, FIG. 1 is a block diagram of a system of Career Navideer for career exploration and exposure according to an embodiment of the present disclosure. FIG. 1 depicts components of a system 100 comprising a career server 102 and a Career Navideer application 104, or application 104 for brevity purposes. The application 104 provides the inventive functionality described herein.

The application 104 comprises a profile module 106, a lifestyle survey module 108, a career exploration module 110, a game module 112, and a my metrics module 114. The application also comprises a student user interface 116, an adult user interface 118, and an organizational administrators and staff users interface 120. These components have been described above.

The system 100 also comprises client devices 122a-c. Discussion of client device 122a to client devices 122b-c unless otherwise stated. The client devices 122a-c are used by young people, students, adults, and administrative personnel and others interested in mapping career and life choices to their career and lifestyle goals. The client devices 122a-c may be mobile devices or desktop computers.

The profile module 106 contains an avatar, guru, theme music and dashboard. The lifestyle survey module 108 is a proprietary algorithm that calculates a lifestyle index. The index is an extrapolation of the amount of money needed to live the chosen lifestyle. The index is based on questions about where the user may want to live, what housing the user may need, the user's eating habits, what transportation the user may need, and whether the user seeks to have children, pets, and luxuries.

The career exploration 110 module identifies and displays occupations that generate income within a range of a lifestyle learning index. The career exploration module 110 provides additional career-related content (some of the content proprietary) on each occupation is explored.

The game module 112 promotes the user to build a class schedule loosely based on their last explored occupation from grades 6-12. The my metrics module 114 provides a collection of reports based on choices made in the application and careers explored. Some reports display proprietary data.

The student user interface 116, the adult user interface 118, and the organizational administrators and staff users interface 120 are described in detail above. While these three components are depicted in FIG. 1 as residing on the career web server 102, in embodiments portions of these components may reside and execute on the client devices 122a-c.

What is claimed is:

1. A system for career exploration and exposure, comprising:
a computer;
an application stored in the computer that when executed:
receives a first message from a client device, the first message providing at least specifications for a future lifestyle and describing vocational interests of a party interested in the future lifestyle,
determines cost of the desired future lifestyle,
determines occupations associated with the described vocational interests,
determines a subset of the occupations able to afford the desired lifestyle based at least on the determined cost, and
sends a second message to the client device, the second message communicating the subset of occupations.

2. The system of claim 1, wherein the specifications comprise at least one of the party's desired residence location, the user's desired housing arrangements, the user's eating habits, the user's transportation requirements, and the user's preferences for children, pets, and luxuries.

3. The system of claim 1, wherein the first message further includes a present education level of the party.

4. The system of claim 3, wherein the system, based on at least one occupation in the subset and further based on the present education level, determines whether further education is needed to fulfill requirements of the at least once occupation.

5. The system of claim 1, wherein the system is directed to students and adults considering career changes.

6. The system of claim 1, wherein determinations of the costs of desired future lifestyle account for cost of living changes.

7. The system of claim 1, wherein the application is web-based and mobile ready.

8. The system of claim 1, wherein the application provides separate interfaces for students, for adults, and for organizational administrators and staff users.

9. A method for career exploration and exposure, comprising:
a survey module presenting a series of questions to a client device, the questions associated with lifestyle preferences of a party;
the module, based on received responses to the questions, determines financial requirements associated with the lifestyle preferences;
the module, based on inputs comprising at least the financial requirements, mapping the inputs to occupations affording lifestyle preferences as expressed in the received responses.

10. The method of claim 9, further comprising the module receiving vocational interests of the party and further reducing the occupations presented to the party based on the interests.

11. The method of claim 9, further comprising the module directing the questions to at least one of the user's desired residence location, the user's desired housing arrangements, the user's eating habits, the user's transportation requirements, and the user's preferences for children, pets, and luxuries.

12. The method of claim 9, wherein method is directed to students in middle school and high school and to adults considering career changes.

13. The method of claim 9, further comprising the survey module receiving a present age and education level of the party.

14. The method of claim 9, further comprising the module, based on at least one of the present age and education level of the user, and further based on the vocational interests, recommending educational curricula for the user to qualify for the occupations.

15. A method for career exploration and exposure, comprising:
a career exploration module receiving a range of a lifestyle learning index, the range describing at least necessary income levels based on lifestyle preferences provided by a client device;
the career exploration module determining occupations affording the range of the lifestyle learning index;
the module displaying the determined occupations to the client device; and
the module, based on vocational interests provided by the client device, communicating a subset of the determined occupations to the client device, the subset matching the vocational interests of a user of the client device.

16. The method of claim 15, wherein the lifestyle preferences comprise at least one of desired residence location, the user's desired housing arrangements, the user's eating habits, the user's transportation requirements, and the user's preferences for children, pets, and luxuries.

17. The method of claim 15, further comprising the module evaluating financial requirements.

18. The method of claim 15, further comprising the module incorporating an age and present education levels of a party associated with the lifestyle preferences into determinations of the occupations.

19. The method of claim 18, further comprising the module, based on the age and present education levels of the party, determining education needs of the party based on the subset of vocational interests.

20. The method of claim 15, further comprising the module incorporating cost of living changes into determinations of the occupations.
